(19) United States
(12) Patent Application Publication
(10) Pub. No.: US 2013/0234360 A1
(43) Pub. Date: Sep. 12, 2013

(54) METHOD AND APPARATUS FOR PRODUCING CELLULOSE ACYLATE FILM

(71) Applicant: FUJIFILM CORPORATION, Tokyo (JP)

(72) Inventor: Syougo KATANO, Kanagawa (JP)

(73) Assignee: FUJIFILM CORPORATION, Tokyo (JP)

(21) Appl. No.: 13/778,545

(22) Filed: Feb. 27, 2013

(30) Foreign Application Priority Data
Mar. 9, 2012 (JP) 2012-053275

(51) Int. Cl. B29D 7/01

(52) U.S. Cl. CPC B29D 7/01
USPC 264/217; 425/224

(57) ABSTRACT

Fatty acid is dissolved in a second solvent to prepare a fatty acid solution. The fatty acid solution is added to a dope prepared by dissolving cellulose acylate and a plasticizer in a first solvent. Thereby, a casting dope containing the fatty acid is prepared. The mass of the fatty acid to be added to the dope is in the range of 1×10⁻⁴ to 3×10⁻³ relative to the sum of the mass of the cellulose acylate and the mass of the plasticizer. The casting dope is discharged from a casting die to the circumferential surface of a drum to form a casting film. The casting film is peeled from the drum and dried to be a film.

### BACKGROUND OF THE INVENTION

1. Field of the Invention

The present invention relates to a method and an apparatus for producing a cellulose acylate film.

2. Description of the Related Art

A solution casting method, as is well known, is a method for producing a film by casting on a support a dope obtained by dissolving a polymer in a solvent to form a casting film, peeling off the casting film as a wet film from the support, and drying the wet film. Cellulose acylate films that are frequently used for optical applications have been produced by such a solution casting method.

Cellulose acylate films have been used as, for example, viewing-angle widening films, polarizing plate protective films, and the like that constitute liquid crystal displays. In recent years, along with rapid extension of a market of the liquid crystal displays, demand for the cellulose acylate films has also rapidly increased. Thus, it is necessary to increase production volume of the cellulose acylate films in existing apparatuses to a large extent.

In order to increase the production volume of the films in existing solution casting apparatuses, a belt or drum as a casting support is caused to move at a higher speed. On the casting support, casting of the dope and peeling off of the casting film are repeatedly performed, and the number of repetition per unit time increases as the speed of film production is made faster. As the speed of film production is made faster, the casting support becomes more rapidly contaminated, though the speed of the casting support being contaminated varies depending on the composition of the dope, the casting conditions, the peeling conditions, and the like. Furthermore, if the production of films is continued while the casting support is contaminated, problems may occur. For example, smoothness of the film surface may be impaired, or contaminants of the casting support may adhere to the film. Therefore, the casting support needs to be washed. However, washing must be carried out while production of the films is halted. Consequently, as the time required for the washing becomes longer, or as the frequency of the washing becomes higher, the film productivity is deteriorated.

Regarding the contaminants of the casting support, there are occasions in which materials that are contained in a casting film but are not visually recognized slowly increase to the extent that clouding is eventually recognized. In the following explanations, the clouding phenomenon that is recognized as such is referred to as plate-out. Various suggestions have been hitherto made regarding the method for preventing plate-out. For example, in the method described in United States Patent Application Publication No. 2008/054215 (corresponding to JP-A-2008-063403), the proportion of the mass of cellulose acylate to the mass of magnesium contained in cellulose acylate is adjusted to a predetermined range, and thereby plate-out is prevented. Furthermore, JP-A-2011-006603 describes a method of adjusting the amount of calcium, the amount of magnesium, and the amount of sulfuric acid in the dope to predetermined ranges, such that a compound having a predetermined skeletal structure is contained in the dope. Thereby, yellowing of the film is prevented while plate-out is suppressed.

The methods described in United States Patent Application Publication No. 2008/054215 (corresponding to JP-A-2008-063403) and JP-A-2011-006603 have certain effects as the method for preventing plate-out. However, even if these methods are used, plate-out may still occur, and therefore, it cannot be said that these methods are perfect methods for suppressing plate-out. The contaminant recognized in the plate-out is so-called wax contained in cellulose acylate. The wax is mainly composed of fatty acid, fatty acid salt, and fatty acid ester. Among them, fatty acid ester is prone to impair the smoothness of the film surface. Furthermore, since cold casting can increase the production speed of the films as compared with dry casting, the cold casting exhibits excellent productivity. However, according to the cold casting, plate-out is more likely to occur as compared with the dry casting, and in particular, fatty acid ester is likely to precipitate out on the casting support. Since fatty acid ester has high molecular weight, it does not easily dissolve even in liquids that are commonly used as solvents. Therefore, fatty acid ester is not easily removed even if it is washed, and cannot be completely removed even if it is wiped with a cloth soaked with a solvent or the like, for example. Even if fatty acid ester can be removed, it takes an enormous amount of time. Meanwhile, the cold casting is a method of hardening a casting film by cooling it on a casting support, and the dry casting is a method of hardening a casting film by drying it on a casting support.

### SUMMARY OF THE INVENTION

In view of the above, an object of the present invention is to provide a method and an apparatus for producing a cellulose acylate film, capable of easily removing contaminants from a casting support by washing the casting support, even if plate-out occurs, by using cellulose acylate containing fatty acid ester.

The method for producing a cellulose acylate film of the present invention includes an adding step (step A), a casting step (step B), a peeling step (step C), and a drying step (step D). In the step A, fatty acid having a carbon number in the range of not less than 12 to not more than 22 is added to a cellulose acylate solution. The cellulose acylate solution is a liquid in which cellulose acylate and a plasticizer are dissolved in a solvent. The fatty acid is added to the cellulose acylate solution in a state that proportion of mass of the fatty acid with respect to sum of mass of the cellulose acylate and mass of the plasticizer is in the range of 1×10⁻⁴ to 3×10³. In the step B, the cellulose acylate solution containing the fatty acid is cast on a surface of a support to form a casting film. The support circulates through a casting position and a peeling position. The casting position is a position at which the cellulose acylate solution is cast. The peeling position is a position at which the casting film formed by the casting is peeled off. In the step C, the casting film is peeled off from the surface of the support. In the step D, the casting film thus peeled off is dried.

The fatty acid is preferably linear fatty acid.

The fatty acid is preferably saturated fatty acid.

It is preferable that the fatty acid is dissolved in a solvent to prepare a fatty acid solution, and the step A is carried out by adding the fatty acid solution to the cellulose acylate solution.

It is preferable that the cellulose acylate solution is continuously supplied to a casting device for carrying out the step B, and the fatty acid solution is continuously added to the cellulose acylate solution that flows toward the casting device.

The apparatus for producing a cellulose acylate film of the present invention includes an adding section, a casting device, a casting die, a support, a peeling device, and a drying device. The adding section adds fatty acid having a carbon number in the range of not less than 12 to not more than 22 to a cellulose acylate solution. The cellulose acylate solution is a liquid in which cellulose acylate and a plasticizer are dissolved in a solvent. The fatty acid is added to the cellulose acylate solution in a state that proportion of mass of the fatty acid with respect to sum of mass of the cellulose acylate and mass of the plasticizer is in the range of 1×10⁻⁴ to 3×10⁻³. The casting device forms a casting film from the cellulose acylate solution containing the fatty acid. The casting die discharges the cellulose acylate solution containing the fatty acid. The casting die is installed in the casting device. The support circulates through a casting position and a peeling position. The support is installed in the casting device. The casting position is a position at which the cellulose acylate solution is cast. The peeling position is a position at which the casting film formed by the casting is peeled off. The peeling device peels the casting film from the support. The drying device dries the casting film thus peeled off.

According to the present invention, it is possible to easily remove contaminants from the casting support by washing the casting support, even if plate-out occurs, by using cellulose acylate containing fatty acid ester.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram of a solution casting apparatus for carrying out a solution casting method.

### DESCRIPTION OF THE PREFERRED EMBODIMENTS

### Solution Casting Apparatus

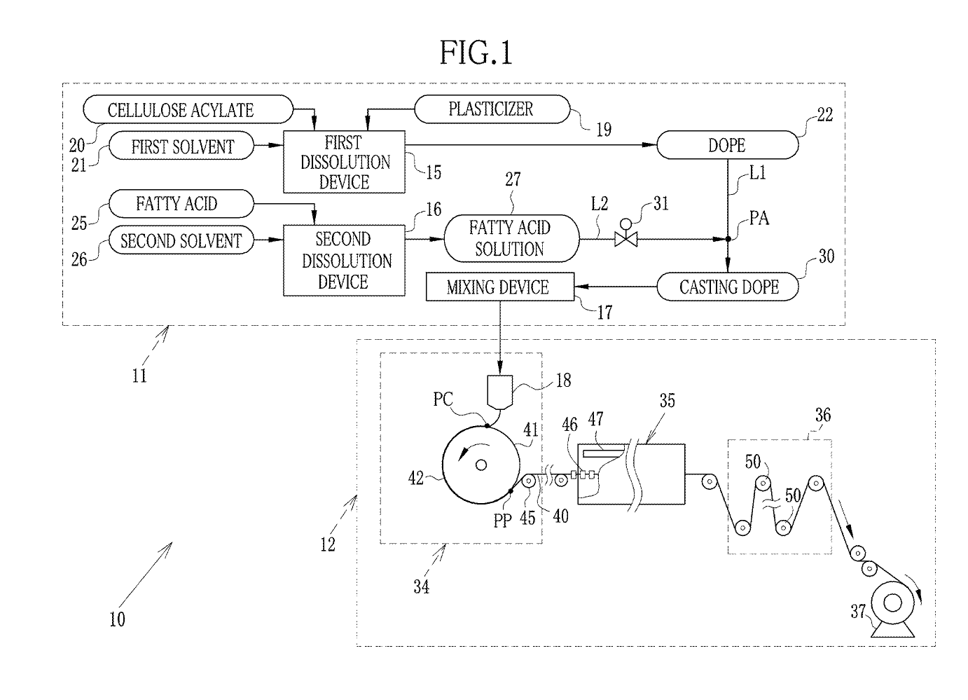

Cellulose acylate films are produced by, for example, using a solution casting apparatus 10 shown in FIG. 1. The solution casting apparatus 10 includes a dope producing unit 11 and a film producing unit 12.

The dope producing unit 11 includes a first dissolution device 15, a second dissolution device 16, and a mixing device 17. The first dissolution device 15 is connected to a casting die 18 of the film producing unit 12 through the mixing device 17. In the first dissolution device 15, cellulose acylate 20 supplied thereto is mixed with a plasticizer 19 and a solvent 21 for cellulose acylate 20 (hereinafter, referred to as a first solvent 21), and the mixture is stirred or heated such that the cellulose acylate 20 is dissolved in the first solvent 21. Thereby, a cellulose acylate solution 22 (hereinafter, referred to as a dope 22) is obtained. In the first dissolution device 15, other materials that are different from the cellulose acylate 20 and the first solvent 21 may be supplied and mixed with the cellulose acylate 20 and the first solvent 21. Examples of the other materials include a matting agent and an ultraviolet absorber.

In the second dissolution device 16, a predetermined fatty acid 25 that has been supplied thereto is mixed with a solvent 26 for the fatty acid 25 (hereinafter, referred to as a second solvent 25), and the mixture is stirred or heated such that the fatty acid 25 is dissolved in the second solvent 26. Thereby, a fatty acid solution 27 is obtained. The predetermined fatty acid 25 will be described in detail later.

The second dissolution device 16 is connected to a first piping L1 for connecting the first dissolution device 15 and the mixing device 17. Thereby, the fatty acid solution 27 is added to the dope 22. When the fatty acid solution 27 is added to the dope 22, a casting dope 30 containing the fatty acid 25 is obtained. A process of adding the fatty acid 25 as described above is hereinafter referred to as an adding process. The first piping L1 extends from the mixing device 17 to the casting die 18 so as to connect them. In a second piping L2 for connecting the second dissolution device 16 and the first piping L1, a valve 31 is provided, and by regulating the opening degree of the valve 31, the amount of the fatty acid solution 27 to be supplied to the first piping L1 is controlled. As the supply amount of the fatty acid solution 27 is controlled, the mass of the fatty acid 25 to be added to the dope 22 is controlled. The amount of the fatty acid 25 to be added to the dope 22 will be described in detail later.

In this embodiment, the dope 22 obtained in the first dissolution device 15 is continuously supplied to the casting die 18, and the fatty acid solution 27 is continuously added to the dope 22 flowing from the first dissolution device 15 to the casting die 18. When the viscosity of the dope 22 is greatly different from that of the fatty acid solution 27, it may be difficult for the two materials to be uniformly mixed. In such a case, as in this embodiment, the mixing device 17 may be disposed between the casting die 18 and an adding position PA at which the fatty acid solution 27 is added to the dope 22, such that a mixture of the dope 22 and the fatty acid solution 27 that has been guided to the mixing device 17 is prepared as a uniform solution by the mixing device 17. The mixing device 17 is, for example, preferably a static type mixing device. Examples of the static type mixing device include a static mixer and a Sulzer mixer.

The adding process may be such that the fatty acid 25 is directly supplied to the dope 22 without being dissolved in the second solvent 26. In this case, the second dissolution device 16 is not used. However, from the viewpoint of mixing the fatty acid 25 with the dope 22 such that the mixture of them becomes uniform more rapidly and reliably, it is preferable that the fatty acid solution 27 is prepared by dissolving the fatty acid 25 in the second solvent 26, and the fatty acid solution 27 is supplied to the dope 22, as in the case of this embodiment.

The film producing unit 12 includes a casting device 34, a tenter 35, a roller drying device 36, and a winding device 37, in this order from the upstream side.

Meanwhile, in the present specification, the solvent content (unit; %) is a value based on dry weight. Specifically, when the mass of the solvent (sum of the mass of the first solvent 21 and the mass of the second solvent 26) is designated as x, and the mass of a film 40 is designated as y, the solvent content (unit; %) is the percentage determined by the formula: {x/(y−x)}×100.

The casting device 34 includes a drum 41 as a casting support and the casting die 18 for discharging the casting dope 30 supplied thereto. The casing die 18 is disposed above the drum 41. In a casting process, the casting dope 30 is continuously discharged from the casting die 18 onto the drum 41 that is rotating in the circumferential direction. Thereby, the casting dope 30 is cast on the drum 41, and thus a casting film 42 is formed. In FIG. 1, a position at which the casting dope 30 is brought into contact with the drum 41 and the formation of the casting film 42 is initiated (hereinafter, referred to as a casting position) is assigned with symbol PC.

The drum 41 includes a temperature controller (not shown in the drawing) that controls a circumferential surface temperature of the drum 41. The temperature of the casting film 42 is adjusted by the drum 41 whose circumferential surface temperature is controlled. For example, in the case of cold casting, if the circumferential surface temperature is adjusted within the range of −15° C. to 10° C., the casting film 42 is cooled and turns into a gel. Through this gelation, the casting film 42 is hardened to be conveyable.

An endless belt formed into a circular shape (not shown in the drawing) may be used as the casting support instead of the drum 41. In the case of using the belt as the casting support, the belt is wound around the circumferential surfaces of a pair of rollers (not shown in the drawing) that rotate in the circumferential direction. At least any one of the pair of rollers may be a driving roller provided with a driving means. As the driving roller rotates in the circumferential direction, the belt that is in contact with the circumferential surface of the driving roller is conveyed. As a result of this conveyance, the belt continuously moves in the longitudinal direction by circulating. In the case of using the belt as the casting support, a temperature of the belt that is in contact with the circumferential surfaces of the rollers may be controlled by a temperature controller (not shown in the drawing) provided to the pair of rollers, for controlling the circumferential surface temperatures of the respective rollers.

In regard to the casting dope 30 extending from the casting die 18 to the drum 41, that is, a so-called bead, a decompression chamber (not shown in the drawing) is provided in an upstream side in the rotational direction of the drum 41. The decompression chamber sucks the atmosphere in an upstream-side area of the casting dope 30 that has been discharged from the casting die 18, and decompresses the area.

The casting film 42 is hardened to the extent that the casting film 42 can be conveyed to the tenter 35, and then the casting film 42 in the state of containing the solvent is peeled off from the circumferential surface of the drum 41. This peeling process is such that in the case of cold casting, for example, the casting film 42 having a solvent content within the range of 150 mass % to 280 mass % is peeled off. At the time of peeling off the casting film 42, the casting film 42 is supported by a roller 45 for peeling (hereinafter, referred to as a peeling roller 45), and a peeling position PP at which the casting film 42 is peeled off from the drum 41 is maintained to be constant.

As discussed above, a film 40 is formed from the casting dope 30 by using the casting device 34. As the circumferential surface of the rotating drum 41 circulates through the casting position PC and the peeling position PP, casting of the casting dope 30 and peeling off of the casting film 42 are repeatedly carried out on the drum 41.

In a conveyance path between the casting device 34 and the tenter 35, an air blowing device (not shown in the drawing) may be disposed. By blowing air from the air blowing device, drying of the film 40 is progressed. The casting film 42 thus peeled off, that is, the film 40, is guided to the tenter 35.

The tenter 35 includes plural pin plates 46 as holding members for holding side ends of the lengthy film 40, a pair of rails (not shown in the drawing), and a pair of chains (not shown in the drawing). The pin plates 46 are disposed such that plural pins (not shown in the drawing) stand up on the top surface of a stand. The tenter 35 holds the side ends of the film 40 by penetrating pins of the pin plates 46 through the side ends of the film 40 guided thereto.

The rails are provided to lateral sides of the conveyance path of the film 40 on a one-to-one basis, and the paired rails are disposed so as to be spaced from each other. The chains are bridged over a driving sprocket and a driven sprocket (not shown in the drawing), and are attached movably along the rails. The plural pin plates 46 are mounted on the chains at a predetermined interval. The rotation of the driving sprocket causes the pin plates 46 to perform circulatory movement along the rails. The pin plates 46 initiate holding of the film 40 thus guided in the vicinity of an inlet port of the tenter 35, and move toward an outlet port of the tenter 35. The holding of the film 40 by the pin plates 46 is released in the vicinity of the outlet port. The pin plates 46 that have released the holding of the film 40 move again to the vicinity of the inlet port, and hold the film 40 that has been newly guided. The side ends of the film 40 are held by the pin plates 46, and the film 40 is conveyed in the longitudinal direction.

The tenter 35 is provided with a duct 47 disposed above the conveyance path for the film 40. At a lower surface of the duct 47, a discharge port for discharging a dry gas (not shown in the drawing) is formed. By blowing a dry gas, drying of the film 40 is progressed while the film 40 is conveyed in the tenter 35. A duct having the same structure may also be provided under the conveyance path of the film 40.

The roller drying device 36 includes plural rollers 50 and an air conditioner (not shown in the drawing). The plural rollers 50 support the film 40 by the circumferential surfaces thereof. The film 40 is wound around the rollers 50, and thereby the conveyance path for the film 40 is defined. The air conditioner regulates the temperature, humidity, and the like inside the roller drying device 36. Thereby, drying of the film 40 is progressed even while the film 40 is conveyed in the roller drying device 36. As such, drying of the film 40 is carried out in both the tenter 35 and the roller drying device 36.

After the film 40 is sent to the winding device 37, the film 40 is wound into a roll. In this manner, the film 40 is produced from the casting dope 30 in the film producing unit 12.

A slitter (not shown in the drawing) may be disposed in the downstream side from the tenter 35 so as to cut off holding marks of the film 40 made by the pins of the pin plates 46. In order to impart a desired optical property, for example, retardation, to the film 40, an additional tenter (not shown in the drawing) may be further disposed between the tenter 35 and the roller drying device 36, or in the downstream side from the roller drying device 36, such that treatments such as stretching of the film 40 in the width direction thereof is carried out by using the tenter.

The film 40 thus obtained can be utilized as an optical film. Examples of the optical film include a protective film for a polarizing plate, or a phase difference film.

In the case of forming a casting film composed of plural layers by sequential casting or co-casting, among the plural casting dopes to be used, as a casting dope for forming the layer to be in contact with the drum 41, the above-mentioned casting dope 30 is preferably used.

The adding process will be described in detail. In the adding process, a predetermined fatty acid 25 is added to the dope 22 in a state that the proportion of the mass of the fatty acid 25 relative to the mass of the solid content of the dope 22 is in the range of 1×10⁻⁴ to 3×10⁻³. That is, when the mass of the solid content of the dope 22 is designated as M1, and the mass of the fatty acid 25 is designated as M2, the mass of the fatty acid 25 which brings a value of the ratio M2/M1 into the range of 1×10⁻⁴ to 3×10⁻³ is determined, and the determined mass of the fatty acid 25 is added to the dope 22. Thereby, the washing property is enhanced. The washing property being satisfactory means that removal of contaminants by washing is easy, that is, contaminants are removed more reliably in a shorter time. The solid content of the dope 22 is composed of the cellulose acylate 20 and the plasticizer 19. If solid components other than the cellulose acylate 20 and the plasticizer 19 are included in the dope 22, the mass of the other solid components may be ignored.

When the predetermined fatty acid 25 is added to the dope 22, the added fatty acid 25 is precipitated out on the circumferential surface of the drum 41 together with fatty acid ester. As compared with the fatty acid ester, the fatty acid 25 has higher solubility relative to the solvent, and therefore the fatty acid 25 is more easily removed by washing. The fatty acid ester is removed together with the fatty acid 25.

However, if the proportion of the mass of the fatty acid 25 with respect to the mass of the solid content of the dope 22 is below 1×10⁻⁴, it cannot be said that the effect of the washing property is reliably obtained. Furthermore, if the proportion of the mass of the fatty acid 25 with respect to the mass of the solid content of the dope 22 is larger than 3×10⁻³, the effect of the washing property may be obtained, but whitening is observed in the film 40 thus obtained, which is not preferable.

As in the case of this embodiment, when the fatty acid 25 in the state of being dissolved in the second solvent 26 is added to the dope 22, the fatty acid solution 27 is supplied to the dope 22, such that the fatty acid 25 is added to the dope 22 in a state that the proportion of the mass of the fatty acid 25 relative to the mass of the solid content of the dope 22 is in the range of 1×10⁻⁴ to 3×10⁻³. For the purpose of supplying the fatty acid solution 27 to the dope 22, there are two methods of adjusting the ratio M2/M1 to the range of 1×10⁻⁴ to 3×10⁻³. According to one of the methods, the mass of the fatty acid solution 27 to be supplied per unit mass of the dope 22 is made to be constant and the concentration of the fatty acid 25 in the fatty acid solution 27 is adjusted before adding the fatty acid solution 27 to the dope 22. According to the other method, the concentration of the fatty acid 25 in the fatty acid solution 27 is made to be constant and the mass of the fatty acid solution 27 to be supplied per unit mass of the dope 22 is adjusted before adding the fatty acid solution 27 to the dope 22.

In view of the solubility of the fatty acid 25 in the dope 22, it is preferable that the concentration of the fatty acid 25 in the fatty acid solution 27 is made to be constant within the range of 1% to 5% and the mass of the fatty acid solution 27 to be supplied per unit mass of the dope 22 is adjusted before adding the fatty acid solution 27 to the dope 22. The concentration of the fatty acid 25 to be added is adjusted by controlling the flow rate of the fatty acid solution 27 relative to the flow rate of the dope 22.

When the fatty acid 25 is added to the dope 22, plate-out is suppressed.

<Fatty Acid>

The fatty acid 25 used in the present invention is fatty acid having a carbon number in the range of 12 to 22. In particular, linear fatty acid is preferably used, saturated fatty acid is more preferably used, and the fatty acid listed in Table 1 is particularly preferably used.

TABLE 1

| Carbon | Name | |
|---|---|---|
| number | (Trivial name inside parentheses) | Molecular formula |
| 10 | Decanoic acid | CH₃—(CH₂)₈—COOH |
| 12 | Dodecanoic acid (Lauric acid) | CH₃—(CH₂)₁₀—COOH |
| 16 | Hexadecanoic acid (Palmitic acid) | CH₃—(CH₂)₁₄—COOH |
| 18 | Octadecanoic acid (Stearic acid) | CH₃—(CH₂)₁₆—COOH |
| 22 | Docosanoic acid (Behenic acid) | CH₃—(CH₂)₂₀—COOH |
| 20 | Eicosanoic acid | CH₃—(CH₂)₁₈—COOH |
| 24 | Tetracosanoic acid | CH₃—(CH₂)₂₂—COOH |
| 26 | Hexacosanoic acid | CH₃—(CH₂)₂₄—COOH |

<Cellulose Acylate>

As for cellulose acylate 20, it is particularly preferable that the degree of hydrogen groups of cellulose esterified for carboxylic acid, that is, the degree of acylation satisfies all of the following formulae (1) to (3). In these formulae (1) to (3), “A” is the degree of substitution of acetyl groups for the hydrogen atoms on the hydroxyl groups of cellulose, and “B” is the degree of substitution of acyl groups for the hydrogen atoms on the hydroxyl groups of cellulose while each acyl group has carbon atoms whose number is from 3 to 22.

2.4≦A+B≦3.0 (1)

0≦A≦3.0 (2)

0≦B≦2.9 (3)

A glucose unit constructing cellulose with β-1,4 bond has free hydroxyl groups at 2nd, 3rd, and 6th positions. The cellulose acylate 20 is a polymer in which, by esterification, the hydrogen atoms on part or all of the hydroxyl groups of cellulose are substituted by the acyl groups having 2 or more carbon atoms. When the esterification of one hydroxyl group in the glucose unit is made at 100%, the degree of substitution is 1. As for cellulose acylate, when the esterification in each hydroxyl group at the 2nd, 3rd, and 6th position is made at 100%, the degree of substitution is 3.

Here, the degree of acylation at the 2nd position in the glucose unit is described as DS2, the degree of acylation at the 3rd position in the glucose unit is described as DS3, and the degree of acylation at the 6th position in the glucose unit is described as DS6. The sum of the degree of acylation, “DS2+DS3+DS6”, is preferably in the range of 2.00 to 3.00, more preferably in the range of 2.22 to 2.90, and further more preferably in the range of 2.40 to 2.88. Moreover, “DS6/(DS2+DS3+DS6)” is preferably at least 0.32, more preferably at least 0.322, and further more preferably in the range of 0.324 to 0.340.

The cellulose acylate may be composed of either one kind of the acyl group, or two or more kinds thereof. It is preferable that, when two or more kinds of the acyl groups are used, one of them is the acetyl group. When the sum of the degree of substitution of the acetyl groups for the hydroxyl groups at the 2nd, 3rd, and 6th positions is represented by DSA, and the sum of the degree of substitution of the acyl groups other than the acetyl groups for the hydroxyl groups at the 2nd, 3rd, and 6th positions is represented by DSB, the value of “DSA+DSB” is preferably in the range of 2.2 to 2.86, and particularly preferably in the range of 2.40 to 2.80. DSB is preferably at least 1.50, and particularly preferably at least 1.7. Additionally, it is preferable that the hydroxyl groups at the 6th position account for at least 28% of DSB, and more preferably at least 30%, and further more preferably at least 31%, and particularly preferably at least 32%. The value of “DSA+DSB” at the 6th position of cellulose acylate is preferably at least 0.75, and more preferably at least 0.80, and particularly preferably at least 0.85. Cellulose acylate with such a composition provides excellent solubility for preparing a polymer solution to be used in the solution casting.

The acyl group with 2 or more carbon atoms in cellulose acylate is not limited particularly, and may be either an aliphatic group or an aryl group. Such acyl group may be, for example, alkylcarbonyl ester of cellulose, alkenylcarbonyl ester of cellulose, aromatic carbonyl ester of cellulose, and aromatic alkylcarbonyl ester of cellulose, and each of them may have further substitutents. Exemplary substitutents are a propionyl group, a butanoyl group, a pentanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexane carbonyl group, an oleoyl group, a benzoyl group, a naphthyl carbonyl group, and a cinnamoyl group. Among them, preferably used are the propionyl group, the butanoyl group, the dodecanoyl group, the octadecanoyl group, the t-butanoyl group, the oleoyl group, the benzoyl group, the naphthyl carbonyl group, and the cinnamoyl group, and more particularly used are the propionyl group and the butanoyl group.

<First Solvent>

As the first solvent 21, solvents which are known as solvents for the dope in the case of producing a cellulose acylate film by solution casting can be used. For example, dichloromethane, various kinds of alcohol, and various kinds of ketone may be used. Furthermore, a mixture of plural solvent components may be used as the first solvent 21. In this case, a mixture obtained by adding a poor solvent of cellulose acylate to a good solvent thereof may also be used.

<Second Solvent>

The second solvent 26 may be a single component or a mixture of plural components, as long as the second solvent 26 includes a good solvent of the fatty acid 25. From the viewpoint of being more reliably and more rapidly homogenized after being added to and mixed with the dope 22, the second solvent 26 more preferably contains compounds common to those used as the components of the first solvent 21.

Hereinafter, Examples of the present invention and Comparative Examples compared with the present invention will be described. The details are described in Examples, and only the conditions that are different from those of Examples will be described in Comparative Examples.

### Examples

The dope 22 having the following composition was prepared by using the first dissolution device 15. The first solvent 21 is a mixture composed of three components, and the first component is dichloromethane, the second component is methanol, and the third component is n-butanol.

| | | |
|---|---|---|
| Cellulose acetate | 100 | parts by mass |
| (based on pulp as a raw material, | | |
| substitution degree of acetyl group: 2.85) | | |
| Triphenyl phosphate | 13 | parts by mass |
| Dichloromethane | 384 | parts by mass |
| Methanol | 54 | parts by mass |
| n-Butanol | 15 | parts by mass |
| Matting agent | 0.03 | parts by mass |
| (AS972, average primary particle | | |
| diameter: 10 nm) | | |

In the second dissolution device 16, the fatty acid 25 and the second solvent 26 were supplied to prepare the fatty acid solution 27. Example 1 to Example 9 were prepared by varying the kind of the fatty acid 25 to be used and the proportion of the mass of the fatty acid 25 relative to the mass of the solid content of the dope 22 (M2/M1). The kind of the fatty acid 25 and M2/M1 for the respective Examples are listed in Table 2. The second solvent 26 had the same composition as that of the first solvent 21.

The fatty acid solution 27 was added to the dope 22 flowing through the first piping L1 from the first dissolution device 15 toward the casting die 18, and thus the casting dope 30 was prepared. The mixing device 17 was provided in the downstream side from the adding position PA of the first piping L1, and the casting dope 30 was mixed and homogenized therein.

The casting dope 30 was continuously cast on the drum 41 of the film producing unit 12 for 3 hours. The width of the circumferential surface of the drum. 41 was 10 cm, and the diameter of the drum 41 was 5 cm. The following evaluation was carried out with regard to the contaminants adhering on the drum 41.

In the respective Examples, the washing property, suppression of plate-out, and transparency of the film 40 were respectively evaluated by the following methods and criteria. The evaluation results for the respective Examples are shown in Table 2. In Table 2, “Ex” denotes Example, and “Com” denotes Comparative Example.

1. Washing Property

While the drum 41 was rotated in a single direction at the speed of 1 m per minute, contaminants adhering to the circumferential surface of the drum 41 were wiped out with a cloth soaked with a solvent. The solvent soaked in the cloth was a mixture obtained by mixing acetone and methylene chloride at a mass ratio of 1/1. The washing property was evaluated according to the following criteria, on the basis of the number of rotations of the drum 41 required to eliminate the contaminants on the drum 41.

A: Contaminants on the drum 41 were eliminated when the number of rotations of the drum 41 was in the range of note less than 1 to not more than 3.

B: Contaminants on the drum 41 were eliminated when the number of rotations of the drum 41 was in the range of note less than 4 to not more than 5.

C: Contaminants on the drum 41 were eliminated when the number of rotations of the drum 41 was in the range of not less than 6 to not more than 10.

D: Contaminants remained on the drum 41 even when the number of rotations of the drum 41 was 11 or more.

Here, A and B are acceptable levels for the washing property, and C and D are unacceptable levels.

2. Suppression of Plate-Out

When plate-out occurs, gloss of the circumferential surface of the drum 41 disappears depending on the amount of contaminants, and the circumferential surface of the drum 41 whitens. Thus, the glossiness of the circumferential surface of the drum 41 was measured, and the effect of suppressing plate-out was evaluated on the basis of the glossiness. The evaluation method was specifically as follows.

(1) Before the film 40 was produced, the drum 41 was disposed in a dark room in advance. In this dark room, the circumferential surface of the drum 41 was irradiated with white light emitted in a predetermined direction with a predetermined angle relative to the circumferential surface of the drum 41. A photoreceiver was disposed at a position different from that of the light source for the white light, and the amount of the white light reflected at the drum was measured by using the photoreceiver. The amount of light thus measured was designated as Q1.

(2) Continuous production of the film 40 was initiated, and at the point of time when 40 hours had passed, production was momentarily stopped.

(3) The drum 41 was detached from the casting device, and the drum 41 was disposed in the dark room again. The amount of reflected light was measured under the same conditions as those in item (1). The amount of light thus measured was designated as Q2.

(4) The value determined by the formula: (Q2/Q1)×100 was designated as the glossiness (unit: %).

A: The glossiness is in the range of not less than 80% to not more than 100%.

B: The glossiness is in the range of not less than 65% to less than 80%.

C: The glossiness is in the range of not less than 50% to less than 65%.

D: The glossiness is in the range of not less than 0% to less than 50%.

Here, A and B are acceptable levels for the effect of suppressing plate-out, and C and D are unacceptable levels.

3. Transparency of Film

If the amount of the fatty acid 25 added to the dope 22 is too large, the fatty acid 25 is precipitated out on the surface of the film 40 as time passes, and the film 40 whitens. The degree of whitening of the film 40 can be measured based on haze. As the degree of whitening increases, the value of haze also increases, so that transparency of the film becomes poor. Furthermore, if the film is subjected to heating, the possibility of precipitation of the fatty acid 25 increases. Thus, transparency of the film 40 was evaluated by the following method.

(1) The film 40 thus obtained was cut into a size of 40 mm×80 mm, and the haze was measured in an environment at 25° C. and 60% RH. The haze was measured according to JIS-6714 by using a haze meter (trade name: HGM-2DP, manufactured by Suga Test Instruments Co., Ltd.). The value thus measured was designated as H1.

(2) The film 40 that had been subjected to the measurement of item (1) was left to stand in an environment at 150° C. for 2 hours.

(3) After the heating treatment of the item (2), the haze of the film 40 was measured with the same haze meter as that used in item (1). The value thus measured was designated as H2.

(4) The change in the haze caused by the heating treatment was determined as the value of H2/H1.

A: The value of H2/H1 is less than 1.2.

B: The value of H2/H1 is in the range of not less than 1.2 to less than 1.5%.

C: the value of H2/H1 is 1.5 or more.

Here, A and B are acceptable levels for the transparency of the film 40, and C is an unacceptable level.

TABLE 2

| | Fatty acid | | | | Evaluation results | | |
|---|---|---|---|---|---|---|---|
| | | Carbon | Molecular | M2/M1 | Washing | | |
| | Name | Number | Weight | (ppm) | property | Plate-out | Transparency of film |
| Ex 1 | Octadecanoic acid | 18 | 284 | 100 | A | B | A |
| Ex 2 | Octadecanoic acid | 18 | 284 | 500 | A | A | A |
| Ex 3 | Octadecanoic acid | 18 | 284 | 1000 | A | A | A |
| Ex 4 | Octadecanoic acid | 18 | 284 | 2000 | A | A | A |
| Ex 5 | Octadecanoic acid | 18 | 284 | 3000 | A | A | B |
| Ex 6 | Dodecanoic acid | 12 | 200 | 500 | A | A | A |
| Ex 7 | Hexadecanoic acid | 16 | 256 | 500 | A | A | B |
| Ex 8 | Eicosanoic acid | 20 | 313 | 500 | A | A | B |
| Ex 9 | Docosanoic acid | 22 | 340 | 500 | A | A | B |
| Com 1 | Not added | — | — | 0 | D | D | A |
| Com 2 | Octadecanoic acid | 18 | 284 | 50 | C | C | A |
| Com 3 | Octadecanoic acid | 18 | 284 | 4000 | A | C | D |
| Com 4 | Octadecanoic acid | 18 | 284 | 80 | C | C | A |
| Com 5 | Decanoic acid | 10 | 172 | 500 | C | C | A |
| Com 6 | Tetracosanoic acid | 24 | 369 | 500 | B | C | D |
| Com 7 | Hexacosanoic acid | 26 | 396 | 500 | B | D | D |

### Comparative Examples

In Comparative Example 1, the fatty acid 25 was not added to the dope 22, and the dope 22 was directly cast. In Comparative Examples 2 to 7, the fatty acid 25 and the second solvent 26 were supplied to the second dissolution device 16, and a fatty acid solution was prepared. The kind of the fatty acid 25 to be used, and the proportion of the mass of the fatty acid 25 with respect to the mass of the solid content of the dope 22 (M2/M1) were varied. The kind of the fatty acid 25 and M2/M1 for the respective Comparative Examples are listed in Table 2. The other conditions were the same as the conditions used in the Examples.

The respective Comparative Examples were subjected to the same evaluations as those carried out for the Examples. The evaluation results are shown in Table 2.

Various changes and modifications are possible in the present invention and may be understood to be within the present invention.

What is claimed is:

1. A method for producing a cellulose acylate film comprising the steps of:
(A) adding fatty acid having a carbon number in the range of not less than 12 to not more than 22 to a cellulose acylate solution obtained by dissolving cellulose acylate and a plasticizer in a solvent, in a state that proportion of mass of said fatty acid with respect to sum of mass of said cellulose acylate and mass of said plasticizer is in the range of 1×10⁻⁴ to 3×10⁻³;
(B) casting said cellulose acylate solution containing said fatty acid on a surface of a support to form a casting film, said support circulating through a casting position and a peeling position, said casting position being a position at which said cellulose acylate solution is cast, and said peeling position being a position at which said casting film formed by the casting is peeled off;
(C) peeling said casting film from the surface of said support; and
(D) drying said casting film thus peeled off.

2. The method for producing a cellulose acylate film according to claim 1, wherein said fatty acid is linear fatty acid.

3. The method for producing a cellulose acylate film according to claim 1, wherein said fatty acid is saturated fatty acid.

4. The method for producing a cellulose acylate film according to claim 2, wherein said fatty acid is saturated fatty acid.

5. The method for producing a cellulose acylate film according to claim 1, wherein said fatty acid is dissolved in a solvent to prepare a fatty acid solution, and the step A is carried out by adding said fatty acid solution to said cellulose acylate solution.

6. The method for producing a cellulose acylate film according to claim 2, wherein said fatty acid is dissolved in a solvent to prepare a fatty acid solution, and the step A is carried out by adding said fatty acid solution to said cellulose acylate solution.

7. The method for producing a cellulose acylate film according to claim 3, wherein said fatty acid is dissolved in a solvent to prepare a fatty acid solution, and the step A is carried out by adding said fatty acid solution to said cellulose acylate solution.

8. The method for producing a cellulose acylate film according to claim 4, wherein said fatty acid is dissolved in a solvent to prepare a fatty acid solution, and the step A is carried out by adding said fatty acid solution to said cellulose acylate solution.

9. The method for producing a cellulose acylate film according to claim 1, wherein said cellulose acylate solution is continuously supplied to a casting device used for carrying out the step B, and said fatty acid solution is continuously added to said cellulose acylate solution that flows toward said casting device.

10. The method for producing a cellulose acylate film according to claim 2, wherein said cellulose acylate solution is continuously supplied to a casting device used for carrying out the step B, and said fatty acid solution is continuously added to said cellulose acylate solution that flows toward said casting device.

11. The method for producing a cellulose acylate film according to claim 3, wherein said cellulose acylate solution is continuously supplied to a casting device used for carrying out the step B, and said fatty acid solution is continuously added to said cellulose acylate solution that flows toward said casting device.

12. The method for producing a cellulose acylate film according to claim 4, wherein said cellulose acylate solution is continuously supplied to a casting device used for carrying out the step B, and said fatty acid solution is continuously added to said cellulose acylate solution that flows toward said casting device.

13. The method for producing a cellulose acylate film according to claim 5, wherein said cellulose acylate solution is continuously supplied to a casting device used for carrying out the step B, and said fatty acid solution is continuously added to said cellulose acylate solution that flows toward said casting device.

14. The method for producing a cellulose acylate film according to claim 6, wherein said cellulose acylate solution is continuously supplied to a casting device used for carrying out the step B, and said fatty acid solution is continuously added to said cellulose acylate solution that flows toward said casting device.

15. The method for producing a cellulose acylate film according to claim 7, wherein said cellulose acylate solution is continuously supplied to a casting device used for carrying out the step B, and said fatty acid solution is continuously added to said cellulose acylate solution that flows toward said casting device.

16. The method for producing a cellulose acylate film according to claim 8, wherein said cellulose acylate solution is continuously supplied to a casting device used for carrying out the step B, and said fatty acid solution is continuously added to said cellulose acylate solution that flows toward said casting device.

17. An apparatus for producing a cellulose acylate film comprising:
an adding section for adding fatty acid having a carbon number in the range of not less than 12 to not more than 22 to a cellulose acylate solution obtained by dissolving cellulose acylate and a plasticizer in a solvent, in a state that proportion of mass of said fatty acid with respect to sum of mass of said cellulose acylate and mass of said plasticizer is in the range of 1×10⁻⁴ to 3×10⁻³;
a casting device for forming a casting film from said cellulose acylate solution containing said fatty acid;
a casting die for discharging said cellulose acylate solution containing said fatty acid, said casting die being installed in said casting device;
a support that circulates through a casting position and a peeling position, said support being installed in said casting device, said casting position being a position at which said cellulose acylate solution is cast, and said peeling position being a position at which said casting film formed by the casting is peeled off;
a peeling device for peeling said casting film from said support; and
a drying device for drying said casting film thus peeled off.
